(19) United States
(12) Patent Application Publication
(10) Pub. No.: US 2002/0094468 A1
(43) Pub. Date: Jul. 18, 2002

(54) Fuel cell system, fuel cell, and hydrogen gas supplying tank

(75) Inventors: Shimpei Miura, Susono-shi (JP); Takeshi Yamamoto, Ama-gun (JP); Kenji Kurita, Susono-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TOYOTA JIDOSHA KABUSHIKI KAISHA, Toyota-shi (JP)

(21) Appl. No.: 10/050,589

(22) Filed: Jan. 18, 2002

(30) Foreign Application Priority Data
Jan. 18, 2001 (JP) 2001-010528

(51) Int. Cl. H01M 8/02

(52) U.S. Cl. 429/34; 429/38; 429/19

(57) ABSTRACT

A shut valve for a hydrogen occluding alloy tank is integrated into a body of the hydrogen occluding alloy tank. Shut valves for a fuel cell are also integrated into a body of the fuel cell. There is no flow passage for communication between the shut valves and the body of the fuel cell. Therefore, it is possible to avoid a situation in which hydrogen gas continues to flow out of the flow passage for communication between the shut valves and the body of the fuel cell despite closure of the valves in response to an inconvenience arising in the flow passage. Even in case of emergency, flow of hydrogen gas can be stopped completely.

### INCORPORATION BY REFERENCE

The disclosure of Japanese Patent Application No. 2001-010528 filed on Jan. 18, 2001 including the specification, drawings, and abstract is incorporated herein by reference in its entirety.

### BACKGROUND OF THE INVENTION

1. Field of the Invention

The invention relates to an onboard fuel cell system, a fuel cell, and a hydrogen gas supplying tank which are suited to be installed in a vehicle such as an automobile or the like.

2. Description of Related Art

A fuel cell, which generates electric power by being supplied with hydrogen gas from a hydrogen gas supplying tank such as a high-pressure hydrogen gas tank, a hydrogen occluding alloy tank, or the like, exhibits high energy efficiency and thus is promising as a power source for an electric vehicle or the like.

In order to use a fuel cell as a power source for a vehicle, the vehicle requires being equipped with a fuel cell system including the fuel cell, a hydrogen gas supplying tank such as a high-pressure hydrogen gas tank or a hydrogen occluding alloy tank, a hydrogen gas flow passage for delivering hydrogen gas from the hydrogen gas supplying tank to the fuel cell, and the like.

However, hydrogen gas is highly combustible. Therefore, if the supply of hydrogen gas is stopped due to an accident or the like of a vehicle equipped with a fuel cell system, it is necessary to prevent leakage of hydrogen gas more reliably. Further, even after the supply of hydrogen gas has been stopped, it is necessary to prevent a situation in which the output voltage of the fuel cell cannot be lowered immediately because a surplus of hydrogen gas remaining in a flow passage of the fuel cell system continues to react in the fuel cell.

### SUMMARY OF THE INVENTION

As described above, it is an object of the invention to provide an onboard fuel cell system, a fuel cell, and a hydrogen gas supplying tank which can more reliably prevent leakage of hydrogen gas during stoppage of the supply of hydrogen gas and which can lower the output voltage immediately after the stoppage of supply of hydrogen gas.

In order to achieve the above-mentioned object at least to some extent, a fuel cell system according to one aspect of the invention comprises a hydrogen gas supplying portion, a fuel cell, a first flow passage, a second flow passage, and a valve. The hydrogen gas supplying portion is designed to supply hydrogen gas. The fuel cell generates electric power by being supplied with the hydrogen gas delivered from the hydrogen gas supplying portion and exhausts the remaining hydrogen gas. A delivery port of the hydrogen gas supplying portion and a supply port of the fuel cell communicate with each other through the first flow passage. The hydrogen gas delivered from the hydrogen gas supplying portion flows through the first flow passage to be supplied to the fuel cell. The second flow passage leads to an exhaust port of the fuel cell. The hydrogen gas exhausted from the fuel cell flows through the second flow passage. The valve is provided in at least one of the supply port and the exhaust port of the fuel cell, can allow or stop flow of the hydrogen gas by being opened or closed, and is integrated into a body of the fuel cell.

Such a fuel cell system constructed according to one aspect of the invention dispenses with the flow passage for communication between the valve and the fuel cell. Thus, even if some inconvenience arises, it is possible to avoid a situation in which hydrogen gas flows out of the flow passage.

Further, since the flow passage for communication between the valve and the body of the fuel cell is dispensed with, there is no hydrogen gas remaining in the flow passage if hydrogen gas is stopped from being supplied to the fuel cell by closing the valve in response to the stoppage of the operation of the fuel cell system. Thus, if the operation of the fuel cell system is stopped so that hydrogen gas is stopped from being supplied to the fuel cell, hydrogen gas in the fuel cell is consumed immediately. Thereby it becomes possible to lower the output voltage of the fuel cell smoothly.

Further, even if the valve is provided in the flow passage for communication between the hydrogen gas supplying portion and the fuel cell without being integrated into the body of the fuel cell, the aforementioned effect can be achieved substantially by disposing the valve close to the fuel cell. That is, if the flow passage for communication between the valve and the fuel cell is shortened, the amount of hydrogen gas remaining in the flow passage after stoppage of the operation of the fuel cell system is reduced. As a result, the same effect as described above can be achieved substantially.

Furthermore, a fuel cell according to one aspect of the invention generates electric power by being supplied with hydrogen gas via a supply port and exhausts the remaining hydrogen gas via an exhaust port. This fuel cell comprises a valve which is provided in at least one of the supply port and the exhaust port, which can allow or stop gas flow by being opened or closed, and which is integrated into a body of the fuel cell.

In addition, a hydrogen gas supplying tank according to one aspect of the invention comprises a valve which is provided in a discharge port for discharging the hydrogen gas and which can allow or stop gas flow by being opened or closed.

If such a fuel cell or such a hydrogen gas supplying tank is employed in a fuel cell system, the same effect as of the aforementioned fuel cell system can be expected.

### BRIEF DESCRIPTION OF THE DRAWINGS

FIG. 1 is a block diagram of an onboard fuel cell system according to a first embodiment, which is one aspect of the invention.

FIG. 2 is a schematic sectional view of a fuel cell according to the first embodiment of the invention.

FIG. 3 is a schematic sectional view of a hydrogen occlusion tank according to the first embodiment of the invention.

FIG. 4 is a block diagram of an onboard fuel cell system according to a second embodiment, which is one aspect of the invention.

### DETAILED DESCRIPTION OF PREFERRED EMBODIMENTS

Hereinafter, embodiments of the invention will be described in the following order:

A. first embodiment

A-1. construction of first embodiment

A-2. operation of first embodiment;

B. second embodiment

B-1. construction of second embodiment

B-2. operation of second embodiment; and

C. modification.

A. first embodiment

A-1. construction of first embodiment

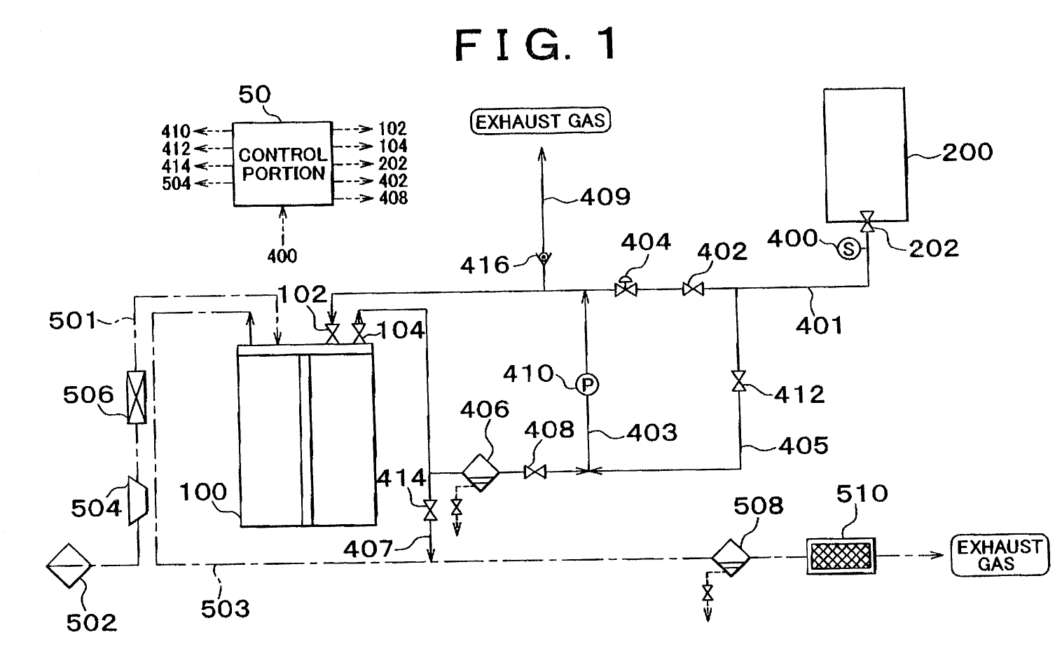

FIG. 1 is a block diagram of an onboard fuel cell system according to the first embodiment of the invention. The fuel cell system of this embodiment is installed in a vehicle such as an automobile or the like. The fuel cell system is mainly composed of a fuel cell 100 and a hydrogen occluding alloy tank 200. The fuel cell 100 is supplied with hydrogen gas and generates electric power. The hydrogen occluding alloy tank 200 is designed as a portion for supplying the fuel cell 100 with hydrogen gas.

The fuel cell 100 is supplied with oxidative gas containing oxygen (e.g., air) as well as hydrogen gas containing hydrogen, causes electrochemical reactions in its hydrogen and oxygen poles according to reaction formulae shown below, and generates electric power.

H₂→2H⁺+2e⁻ (1)

2H⁺+2e⁻+(½)O₂→H₂O (2)

H₂+(½)O₂→H₂O (3)

That is, if the hydrogen pole and the oxygen pole are supplied with hydrogen gas and oxidative gas respectively, the reaction according to the formula (1) and the reaction according to the formula (2) occur on the side of the hydrogen pole and on the side of the oxygen pole respectively. As a whole, the reaction according to the formula (3) occurs in the fuel cell.

If the fuel cell 100 thus constructed is employed as a power source for a vehicle, an electric motor (not shown) is driven by electric power generated by the fuel cell 100. A torque generated by the electric motor is transmitted to axles (not shown) and serves as a force for propelling the vehicle.

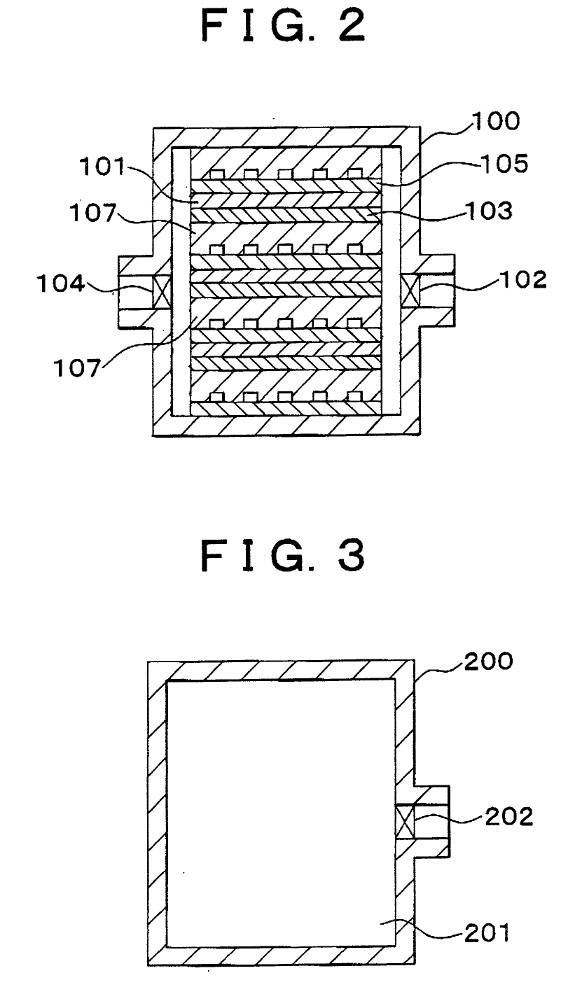

Further, as shown in FIG. 2, the fuel cell 100 has a stacked structure. That is, a plurality of single cells are stacked and thus constitute the fuel cell 100. Each of the single cells is composed of an electrolytic film 101, a hydrogen pole 103, an oxygen pole 105, and two separators 107. The hydrogen pole 103 and the oxygen pole 105 are diffusion electrodes between which the electrolytic film 101 is interposed on its opposed sides. Furthermore, the hydrogen pole 103 and the oxygen pole 105 are interposed between the separators 107. A single-cell gas flow passage is formed in each face of each of the separators 107. While the hydrogen pole 103 and the oxygen pole 105 are interposed between the separators 107, the single-cell gas flow passage assumes a convexo-concave shape between the hydrogen pole 103 or the oxygen pole 105 and a corresponding one of the separators 107. Hydrogen gas that has been supplied as described above flows through the single-cell gas flow passage formed between the hydrogen pole 103 and a corresponding one of the separators 107. Further, oxidative gas flows through the single-cell gas flow passage formed between the oxygen pole 105 and a corresponding one of the separators 107. The fuel cell 100 is also provided with shut valves 102, 104.

On the other hand, as shown in FIG. 3, the hydrogen occluding alloy tank 200 includes a hydrogen occluding alloy 201. In general, the hydrogen occluding alloy 201 has the properties of causing an endothermic reaction and discharging hydrogen when heated and causing an exothermic reaction and occluding hydrogen when cooled. Accordingly, if hydrogen is extracted from the hydrogen occluding alloy 201, the hydrogen occluding alloy 201 in the hydrogen occluding alloy tank 200 is heated by means of a heat exchange system (not shown).

It is to be noted herein that since the hydrogen occluding alloy 201 deteriorates in the presence of impurities, highly pure hydrogen is accumulated in the hydrogen occluding alloy tank 200. The hydrogen occluding alloy tank 200 is provided with a shut valve 202.

As shown in FIG. 1, the fuel cell system of this embodiment has a hydrogen gas flow passage through which hydrogen gas flows in the system, an oxidative gas flow passage through which oxidative gas flows in the system, and a control portion 50.

The hydrogen gas flow passage is composed of a main flow passage 401, a circulation flow passage 403, a bypass flow passage 405, an exhaust flow passage 407, and a relief flow passage 409. The main flow passage 401 extends from a discharge port of the hydrogen occluding alloy tank 200 to a supply port of the fuel cell 100. The circulation flow passage 403 extends from an exhaust port of the fuel cell 100 via a later-described pump 410 to the main flow passage 401. The bypass flow passage 405 branches off from the main flow passage 401 and leads to the circulation flow passage 403. The exhaust flow passage 407 is designed to exhaust impurities contained in hydrogen gas that is in circulation. The relief flow passage 409 is designed to exhaust hydrogen gas in the case of application of an abnormal pressure.

The shut valve 202, which characterizes the invention, is disposed in the main flow passage 401 at the discharge port of the hydrogen occluding alloy tank 200. The main flow passage 401 extends across a pressure sensor 400, a shut valve 402, and a pressure-reducing valve 404. The shut valve 102, which characterizes the invention, is disposed at the supply port of the fuel cell 100. Further, the shut valve 104, which characterizes the invention, is disposed in the circulation flow passage 403 at the exhaust port of the fuel cell 100. The circulation flow passage 403 extends across a gas-liquid separator 406, a shut valve 408, and a pump 410. Furthermore, a shut valve 412 is disposed in the bypass flow passage 405. A shut valve 414 is disposed in the exhaust flow passage 407. A relief valve 416 is disposed in the relief flow passage 409.

It is to be noted herein that the shut valves 202, 102, and 104, which characterize the invention, will be described later in detail.

On the other hand, the oxidative gas flow passage has an oxidative gas supply flow passage 501 for supplying the fuel cell 100 with oxidative gas and an oxygen-off gas exhaust flow passage 503 for exhausting oxygen-off gas that has been exhausted from the fuel cell 100.

An air cleaner 502, a compressor 504, and a humidifier 506 are disposed in the oxidative gas supply flow passage 501. Further, a gas-liquid separator 508 and a combustor 510 are disposed in the oxygen-off gas exhaust flow passage 503.

A detection result obtained from a pressure sensor 460 is inputted to the control portion 50. The control portion 50 controls the shut valves 102, 104, 202, 402, 408, 412, and 414, the pump 410, and the compressor 504 respectively. It is to be noted herein that control lines and the like are omitted for the sake of simplicity of the drawing.

A-2. operation of first embodiment

First of all, it will be described briefly how oxidative gas flows. The control portion 50 drives the compressor 504, whereby air contained in the atmosphere is introduced as oxidative gas. The oxidative gas that has been introduced is purified by the air cleaner 502, flows through the oxidative gas supply flow passage 501, and is supplied to the fuel cell 100 via the humidifier 506. The oxidative gas that has been thus supplied is used for the aforementioned electrochemical reactions in the fuel cell 100 and then is exhausted as oxygen-off gas. The oxidative gas that has been exhausted flows through the oxygen-off gas exhaust flow passage 503 and is exhausted to the atmosphere outside the vehicle via the gas-liquid separator 508 and the combustor 510.

It will now be described how hydrogen gas flows. The control portion 50 basically holds the shut valve 202 in the hydrogen occluding alloy tank 200 and the shut valves 102, 104 in the fuel cell 100 open while the fuel cell system is in operation, and holds them closed while the fuel cell system is out of operation.

Further, during normal operation, although the control portion 50 holds the shut valve 402 in the main flow passage 401 and the shut valve 408 in the circulation flow passage 403 open, the shut valve 412 in the bypass flow passage 405 and the shut valve 414 in the exhaust flow passage 407 are closed. It is to be noted herein that the relief valve 416 is closed except in the case of application of an abnormal pressure or the like. The pressure sensor 400 detects a pressure of hydrogen gas discharged from the hydrogen occluding alloy tank 200.

During -normal operation, as described above, hydrogen gas is discharged if the hydrogen occluding alloy 201 in the hydrogen occluding alloy tank 200 is heated by the heat exchange system. The hydrogen gas that has been discharged flows through the main flow passage 401, is depressurized by the pressure-reducing valve 404, and then is supplied to the fuel cell 100. The hydrogen gas that has been thus supplied is used for the aforementioned electrochemical reactions in the fuel cell 100 and then is exhausted as hydrogen-off gas. The hydrogen gas that has been exhausted flows through the circulation flow passage 403 and is removed of liquid water contents contained therein by the gas-liquid separator 406. The hydrogen-off gas that has been removed of the liquid water contents is returned to the main flow passage 401 via the pump 410 and is supplied to the fuel cell 100 again. The pump 410 disposed in the circulation flow passage 403 is driven at this moment, whereby hydrogen-off gas flowing through the circulation flow passage 403 gushes out to the main flow passage 401. Thus, during normal operation, hydrogen gas circulates through the main flow passage 401 and the circulation flow passage 403.

Hydrogen gas flows as described hitherto during normal operation. It will now be described how hydrogen gas flows at the time of cold start.

In general, the pressure of hydrogen discharged from the hydrogen occluding alloy 201 is increased in proportion to a rise in temperature and is reduced in proportion to a fall in temperature. Thus, hydrogen becomes less likely to be discharged as the temperature of the hydrogen occluding alloy tank 200 falls. Therefore, the fuel cell system is designed to extract hydrogen gas from the hydrogen occluding alloy tank 200 by means of the pump 410 at the time of cold start.

If the ambient temperature is low in starting the fuel cell system, the pressure of hydrogen gas detected by the pressure sensor 400 may be lower than a reference pressure. In such a case, the control portion 50 closes the shut valve 402 in the main flow passage 401, the shut valve 408 in the circulation flow passage 403, and the shut valve 414 in the exhaust flow passage 407, and opens the shut valve 412 in the bypass flow passage 405. Even in the case where the hydrogen occluding alloy tank 200 is at a low temperature while discharging hydrogen gas at a low temperature, since the control portion 50 drives the pump 410 at a high speed, a sufficient amount of occluded hydrogen gas is extracted from the hydrogen occluding alloy tank 200. The hydrogen gas that has been thus extracted enters the bypass flow passage 405 from the main flow passage 401, flows through the circulation flow passage 403, returns to the main flow passage 401, and is supplied to the fuel cell 100. The hydrogen gas that has been thus supplied is used for the electrochemical reactions in the fuel cell 100, turns into hydrogen-off gas, and is exhausted to the circulation flow passage 403. It is to be noted herein that the concentration of impurities contained in hydrogen-off gas increases as time passes. Accordingly, with a view to removing the impurities, the control portion 50 occasionally opens the shut valve 414 so as to discharge hydrogen-off gas from the exhaust flow passage 407.

Hydrogen gas flows substantially as described hitherto in this embodiment. The shut valves 202, 102, and 104, which characterize the invention, will now be described in detail.

If a vehicle equipped with a fuel cell system collides or if a control system for the fuel cell system suffers a malfunction, leakage of hydrogen gas and the like may be caused. In this embodiment, as soon as vibration resulting from an accident such as a collision or the like or a malfunction or the like of the control system is sensed, the control portion 50 automatically closes the shut valve 202 in the hydrogen occluding alloy tank 200 and the shut valves 102, 104 in the fuel cell 100. By stopping hydrogen gas from being discharged from the hydrogen occluding alloy tank 200, from being supplied to the fuel cell 100, and from being exhausted therefrom, leakage of hydrogen gas is prevented.

In this embodiment, as shown in FIG. 3, the shut valve 202 is integrated into the body of the hydrogen occluding alloy tank 200. It is assumed herein that the shut valve 202 is disposed apart from the body of the hydrogen occluding alloy tank 200. In this case, if the flow passage for communication between the shut valve 202 and the body of the hydrogen occluding alloy tank 200 suffers an inconvenience (e.g., cracking or the like), it may become impossible to completely stop hydrogen gas from leaking out from the flow passage despite closure of the shut valve 202. On the contrary, if the shut valve 202 is integrated into the body of the hydrogen occluding alloy tank 200 as described above, there is no flow passage for communication between the shut valve 202 and the body of the hydrogen occluding alloy tank 200. Therefore, if the inconvenience as described above arises, leakage of hydrogen gas can be stopped completely.

Further, according to this embodiment, the shut valves 102, 104 are also integrated into the body of the fuel cell 100 as shown in FIG. 2. Accordingly, as in the case of the hydrogen occluding alloy tank 200, there is no flow passage for communication between the shut valves 102, 104 and the body of the fuel cell 100. Therefore, if some inconvenience arises, leakage of hydrogen gas can be stopped completely.

Further, the shut valves 102, 104 may be installed close to the body of the fuel cell 100. It is assumed herein that the shut valve 102 on the side of the supply port is disposed apart from the body of the fuel cell 100. In this case, even if the shut valve 102 is closed upon stoppage of the operation of the fuel cell system, hydrogen gas remains in the flow passage for communication between the shut valve 102 and the body of the fuel cell 100. For this reason, the fuel cell 100 may continue to output a high voltage for a while until hydrogen gas contained therein is consumed. Thus, there are apprehensions that it might be impossible to lower the voltage of the fuel cell immediately even if the supply of hydrogen gas has been stopped and that it might be impossible to perform control of the voltage smoothly.

On the contrary, if the shut valve 102 is integrated into the body of the fuel cell 100 as described above, there is no flow passage for communication therebetween. If the shut valve 102 is disposed close to the body of the fuel cell 100 as described above, such a flow passage exists but its length is negligible. Accordingly, if the shut valve 102 is closed through stoppage of the operation of the fuel cell system, the amount of hydrogen gas remaining in the flow passage is extremely small. For this reason, the remaining hydrogen gas is consumed earlier on, and the output voltage of the fuel cell 100 drops immediately. Thus, it is possible to perform control of the voltage smoothly.

B. second embodiment

B-1. construction of second embodiment

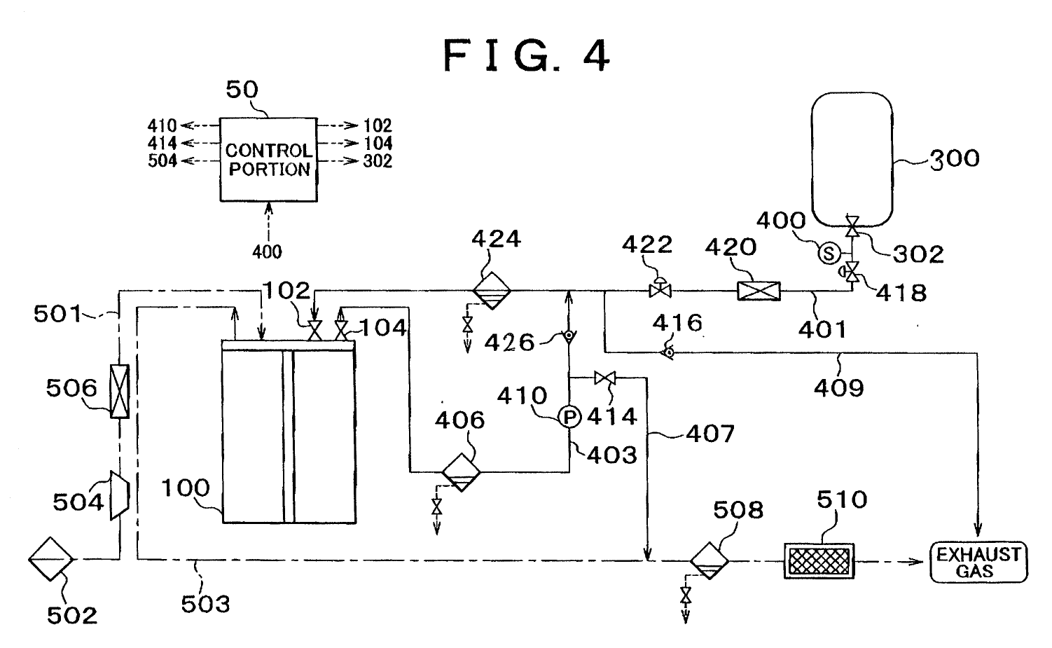

FIG. 4 is a block diagram of an onboard fuel cell system according to the second embodiment of the invention. Although the fuel cell system of the first embodiment employs the hydrogen occluding alloy tank 200 as a supply source of hydrogen gas, the fuel cell system of this embodiment employs a high-pressure hydrogen gas tank 300 instead of the hydrogen occluding alloy tank 200 as a hydrogen gas supplying portion.

The high-pressure hydrogen gas tank 300 is filled with high-pressure hydrogen gas. A shut valve 302 is provided at the root of a hydrogen gas supplying port of the high-pressure hydrogen gas tank 300. If the shut valve 302 is opened, hydrogen gas having a pressure of about 20 to 35 MPa is discharged.

Further, the fuel cell 100 is identical in structure with that of the first embodiment. That is, the shut valves 102, 104 are integrated into or installed close to the body of the fuel cell 100.

Moreover, as shown in FIG. 4, the fuel cell system of this embodiment has a hydrogen gas flow passage, an oxidative gas flow passage, and the control portion 50. Because the oxidative gas flow passage is identical in structure with that of the first embodiment, it will not be described again below.

The hydrogen gas flow passage is composed of the main flow passage 401, the circulation flow passage 403, the exhaust flow passage 407, and the relief flow passage 409. The main flow passage 401 extends from a discharge port of the high-pressure hydrogen gas tank 300 to the supply port of the fuel cell 100. The circulation flow passage 403 extends from the exhaust port of the fuel cell 100 via the pump 410 back to the main flow passage 401. The exhaust flow passage 407 is designed to exhaust impurities contained in hydrogen gas that is in circulation. The relief flow passage 409 is designed to exhaust hydrogen gas in the case of application of an abnormal pressure. The high-pressure hydrogen gas tank 300, which is employed as a tank for supplying hydrogen gas in this embodiment, can discharge high-pressure hydrogen gas irrespective of the temperature. Accordingly, unlike the case of the hydrogen occluding alloy tank 200, the fuel cell system of this embodiment does not require extracting hydrogen gas at the time of cold start and thus is not provided with the bypass flow passage 405.

The hydrogen 302 is disposed at the discharge port of the high-pressure hydrogen gas tank 300. Further, the main flow passage 401 extends across a pressure-reducing valve 418, a heat exchanger 420, a pressure-reducing valve 422, and a gas-liquid separator 424. The shut valve 102 is disposed at the supply port of the fuel cell 100. Further, the shut valve 104 is disposed in the circulation flow passage 403 at the exhaust port of the fuel cell 100. The circulation flow passage 403 extends across the gas-liquid separator 406, the pump 410, and a check valve 426. The second embodiment is identical with the first embodiment in that the shut valve 414 is disposed in the exhaust flow passage 407 and that the relief valve 416 is disposed in the relief flow passage 409.

A detection result obtained from the pressure sensor 400 is inputted to the control portion 50. Further, the control portion 50 controls the shut valves 102, 104, 302, and 414, the pump 410, and the compressor 504. It is to be noted herein that control lines and the like are omitted for the sake of simplicity of the drawing.

B-2. operation of second embodiment

It will now be described briefly how hydrogen gas flows. It is to be noted herein that since oxidative gas flows in the same manner as in the first embodiment, it will not be described again below how oxidative gas flows.

The control portion 50 basically holds the shut valve 302 in the high-pressure hydrogen gas tank 300 and the shut valves 102, 104 in the fuel cell 100 open while the fuel cell system is in operation, and holds them closed while the fuel cell system is out of operation.

Further, during normal operation, the control portion 50 holds the shut valve 414 in the exhaust flow passage 407 closed. It is to be noted herein that the relief valve 416 is closed except in the case of application of an abnormal pressure or the like, as in the case of the first embodiment.

During normal operation, as described above, hydrogen gas is discharged from the high-pressure hydrogen gas tank 300 if the control portion 50 opens the shut valve 302. The hydrogen gas that has been discharged flows through the main flow passage 401, is depressurized by the pressure-reducing valve 418, and then is warmed by the heat exchanger 420. The hydrogen gas that has been warmed is further depressurized by the pressure-reducing valve 422, is removed of liquid water contents contained therein by the gas-liquid separator 424, and is supplied to the fuel cell 100. The hydrogen gas that has been thus supplied is used for the aforementioned electrochemical reactions in the fuel cell 100 and then is exhausted as hydrogen-off gas. The hydrogen-off gas that has been exhausted flows through the circulation flow passage 403 and is removed of liquid water contents contained therein by the gas-liquid separator 406. The hydrogen-off gas that has been removed of its liquid water contents is returned to the main flow passage 401 via the pump 410 and is supplied to the fuel cell 100 again. At this moment, as in the case of the first embodiment, the pump 410 disposed in the circulation flow passage 403 is driven, whereby hydrogen-off gas flowing through the circulation flow passage 403 gushes out to the main flow passage 401. Thus, hydrogen gas circulates through the main flow passage 401 and the circulation flow passage 403 during normal operation. It is to be noted herein that the check valve 426 is provided in the circulation flow passage 403 between a point of connection to the main flow passage 401 and the pump 410 so as to prevent hydrogen-off gas that is in circulation from flowing backwards.

Hydrogen gas flows as described hitherto in this embodiment. The shut valves 202, 102, and 104, which characterize the invention, will now be described. As in the case of the first embodiment, this embodiment is also designed such that as soon as collision of a vehicle equipped with the fuel cell system or a malfunction or the like of the control system for the fuel cell system is sensed, the control portion 50 automatically closes the shut valve 302 in the high-pressure hydrogen gas tank 300 and the shut valves 102, 104 in the fuel cell 100. By stopping hydrogen gas from being discharged from the high-pressure hydrogen gas tank 300, from being supplied to the fuel cell 100, and from being exhausted therefrom, leakage of hydrogen gas is prevented.

Further, as described above, the fuel cell 100 of this embodiment is identical in structure with that of the first embodiment. That is, the shut valves 102, 104 are integrated into or installed close to the body of the fuel cell 100. Accordingly, also in this embodiment, if the shut valves 102, 104 are integrated into the body of the fuel cell 100, there is no flow passage for communication between the shut valves 102, 104 and the body of the fuel cell 100. Thus, if some inconvenience arises, leakage of hydrogen gas can be stopped completely. Further, if the shut valves 102, 104 are installed close to the body of the fuel cell 100, the amount of hydrogen gas remaining in the flow passage for communication between the fuel cell 100 and the high-pressure hydrogen gas tank 300 is extremely small when the shut valve 102 is closed due to the stoppage of operation. Thus, the output voltage of the fuel cell 100 drops immediately, and it is possible to perform control of the voltage smoothly.

C. modification

It is to be noted herein that the invention is not to be limited to the aforementioned embodiments and can be implemented in various forms without departing the spirit thereof.

In the aforementioned first and second embodiments, the fuel cell 100 into which the shut valves 102, 104 are integrated is applied to the fuel cell system employing the hydrogen occluding alloy tank 200 or the high-pressure hydrogen gas tank 300. However, the invention is not to be limited thereto and is also applicable to a fuel cell system in which a reformer or the like for producing hydrogen gas by reforming raw fuel is employed as a source for supplying hydrogen gas.

What is claimed is:

1. A fuel cell system comprising:
a hydrogen gas supplying portion for supplying hydrogen gas;
a fuel cell which generates electric power by being supplied with the hydrogen gas delivered from the hydrogen gas supplying portion and which exhausts the remaining hydrogen gas;
a first flow passage through which a delivery port of the hydrogen gas supplying portion and a supply port of the fuel cell communicate with each other and through which the hydrogen gas delivered from the hydrogen gas supplying portion flows to be supplied to the fuel cell;
a second flow passage which leads to an exhaust port of the fuel cell and through which the hydrogen gas exhausted from the fuel cell flows; and
a valve which is provided in at least one of the supply port and the exhaust port of the fuel cell, which can allow or stop flow of the hydrogen gas by being opened or closed, and which is integrated into a body of the fuel cell.

2. The fuel cell system according to claim 1, wherein the valve is built into the fuel cell.

3. The fuel cell system according to claim 1, wherein the valve is directly mounted to the fuel cell on its outer side.

4. The fuel cell system according to claim 1, wherein the valve is connected to the fuel cell without interposing a flow passage member through which the hydrogen gas flows.

5. The fuel cell system according to claim 1, wherein the valve is built into the hydrogen gas supplying portion.

6. The fuel cell system according to claim 1, wherein the valve is directly mounted to the hydrogen gas supplying portion on its outer side.

7. The fuel cell system according to claim 1, wherein the valve is connected to the hydrogen gas supplying portion without interposing a flow passage member through which the hydrogen gas flows.

8. The fuel cell system according to claim 1, wherein the hydrogen gas supplying portion is a hydrogen occluding metal tank having a hydrogen gas storing alloy capable of occluding and discharging hydrogen gas.

9. The fuel cell system according to claim 1, wherein the hydrogen gas supplying portion is a high-pressure hydrogen gas tank in which hydrogen gas is accumulated.

10. The fuel cell system according to claim 1, wherein the second flow passage is connected to the first flow passage.

11. A fuel cell system comprising:
a hydrogen gas supplying portion for supplying hydrogen gas;
a fuel cell which generates electric power by being supplied with the hydrogen gas delivered from the hydrogen gas supplying portion;
a flow passage through which a discharge port of the hydrogen gas supplying portion and a supply port of the fuel cell communicate with each other and through which the hydrogen gas discharged from the hydrogen gas supplying portion flows to be supplied to the fuel cell; and
a valve which is provided in the discharge port of the hydrogen gas supplying portion, which can allow or stop gas flow by being opened or closed, and which is integrated into a body of the hydrogen gas supplying portion.

12. The fuel cell system according to claim 11, wherein the valve is built into the fuel cell.

13. The fuel cell system according to claim 11, wherein the valve is directly mounted to the fuel cell on its outer side.

14. The fuel cell system according to claim 11, wherein the valve is connected to the fuel cell without interposing a flow passage member through which the hydrogen gas flows.

15. The fuel cell system according to claim 11, wherein the valve is built into the hydrogen gas supplying portion.

16. The fuel cell system according to claim 11, wherein the valve is directly mounted to the hydrogen gas supplying portion on its outer side.

17. The fuel cell system according to claim 11, wherein the valve is connected to the hydrogen gas supplying portion without interposing a flow passage member through which the hydrogen gas flows.

18. The fuel cell system according to claim 11, wherein the hydrogen gas supplying portion is a hydrogen occluding metal tank having a hydrogen gas storing alloy capable of occluding and discharging hydrogen gas.

19. The fuel cell system according to claim 11, wherein the hydrogen gas supplying portion is a high-pressure hydrogen gas tank in which hydrogen gas is accumulated.

20. A fuel cell which generates electric power by being supplied with hydrogen gas via a supply port and which exhausts the remaining hydrogen gas via an exhaust port, comprising:
a valve which is provided in at least one of the supply port and the exhaust port, which can allow or stop gas flow by being opened or closed, and which is integrated into a body of the fuel cell.

21. The fuel cell according to claim 20, wherein the valve is built into the fuel cell.

22. The fuel cell according to claim 20, wherein the valve is directly mounted to the fuel cell on its outer side.

23. The fuel cell according to claim 20, wherein the valve is connected to the fuel cell without interposing a flow passage member through which the hydrogen gas flows.

24. A hydrogen gas supplying portion comprising: a valve which is provided in a discharge port for discharging the hydrogen gas, which can allow or stop gas flow by being opened or closed, and which is integrated into a body of the hydrogen gas supplying portion.

25. The hydrogen gas supplying portion according to claim 24, wherein the valve is built into the hydrogen gas supplying portion.

26. The hydrogen gas supplying portion according to claim 25, wherein the valve is directly mounted to the hydrogen gas supplying portion on its outer side.

27. The hydrogen gas supplying portion according to claim 25, wherein the valve is connected to the hydrogen gas supplying portion without interposing a flow passage member through which the hydrogen gas flows.

28. The hydrogen gas supplying portion according to claim 25, wherein the hydrogen gas supplying portion is a hydrogen occluding metal tank having a hydrogen gas storing alloy capable of occluding and discharging hydrogen gas.

29. The hydrogen gas supplying portion according to claim 25, wherein the hydrogen gas supplying portion is a high-pressure hydrogen gas tank in which hydrogen gas is accumulated.
